(19) United States
(12) Patent Application Publication
(10) Pub. No.: US 2004/0050561 A1
(43) Pub. Date: Mar. 18, 2004

(54) Method and apparatus for tilling an agricultural field

(75) Inventors: Dennis L. Lewallen, Beloit, KS (US); Jeffrey S. Hughes, Glen Elder, KS (US)

Correspondence Address: TROUTMAN SANDERS LLP, BANK OF AMERICA PLAZA, SUITE 5200, 600 PEACHTREE STREET , NE, ATLANTA, GA, 30308-2216, US

(73) Assignee: Sunflower Manufacturing Company, Inc.,

(21) Appl. No.: 10/214,765

(22) Filed: Aug. 9, 2002

(51) Int. Cl. A01B 49/02

(52) U.S. Cl. 172/142

(57) ABSTRACT

A method and apparatus for tilling a field that includes a frame, a ground engaging tool attached to the frame wherein the ground engaging tool creates an initial residue flow pattern and a spike tooth linked to the fame and positioned approximately inline with the initial residue flow pattern, wherein the tooth alters the flow pattern of the residue.

### FIELD OF THE INVENTION

The present invention relates generally to a method and apparatus for tilling agricultural fields. More particularly, the present invention relates to using a spike tooth configuration in selected positions in relation to a ground engaging tool configuration to till a field.

### BACKGROUND OF THE INVENTION

The need to till and cultivate soil for the planting of crops has been recognized as an important factor in crop yield. Tillage devices have ranged in size from the ordinary garden hoe to the larger devices of today that are hitched to mechanical towing devices such as tractors. The tillage devices, depending on the type of crops, quantity and soil being tilled, are different in complexity and size. Further complicating modern day tillage tools is the emphasis on conserving natural resources, resulting in modern tillage systems that have been altered to address these concerns. Further, environmental and efficiency concerns have resulted in larger and more complex tillage systems.

Previously, an agricultural tractor would pull a relatively small tillage device or cultivator. As the tillage device or cultivator moved over hills and similar undulations in the terrain all the ground-working implements maintained contact with the soil. The width of the tillage device was sufficiently small such that it generally did not have problems maintaining ground contact. However, as the tillage devices were increased in width, so as to be able to till a greater area in a single pass, the undulations in the ground resulted in the ground-working tools failing to always contact the earth. Also, to transport the tillage device or cultivator for the farming operations, it was also necessary for the device to be capable of being collapsed to a width sufficient to be moved. To accomplish these goals, a center section with a set of pivotable wings was designed. The wings could pivot horizontally relative to the center section allowing the tillage device to accommodate some undulations in the ground. The wings could also be folded into the center section allowing for easy transport before and after farming operations. Eventually, an additional outer set of wings was added increasing the width of the tillage device.

These larger tillage systems allow a single operator to perform tillage operations on a greater area. However, the larger tillage system sometimes results in a number of different problems. For example, one such system used to till is a spike tooth system, which is used is combination with a ground engaging tool to till the field. One of the main drawbacks of the current spike tooth is the inability of the tooth to go through heavy crop residue. As a result, the residue tends to gather and become a hindrance. Two actions result from this build-up in crop residue. One is that the operator must stop and raise the tillage device in order to remove the gathered residue. The other result is that residue lifts up the tooth section and at some point dumps the accumulated pile out of the rear of the machine. When the latter occurs, the field does not become completely tilled. As a result, uneven amounts of residue or piles are left on the field.

These piles can hamper the seeding operation of the next crop and can cause an uneven incorporation of chemicals. In a large field with heavy crop residue these piles can have a substantial effect on crop yield.

There are several reasons why heavy crop residue fails to go through current tillage devices. One of the causes is the poor placement of the residue clearing devices as they relate to the residue created from tilling a field. This results in situations where heavy crop residue is not allowed to flow in an efficient manner. Therefore, there is a need for a tillage apparatus that permits efficient tilling of a field, especially in heavy residue situations. There is a further need to allow for efficient tilling and processing of the heavy residue such that the laying of chemical and seeds is not a problem.

### SUMMARY OF THE INVENTION

It is therefore a feature and advantage of the present invention to provide a method and apparatus for tilling a field in an efficient manner such that the residue is spread in an even pattern.

In another aspect of the present invention, a tillage apparatus includes a frame, a ground engaging tool, which creates an initial residue flow pattern, attached to the frame, and a tooth linked to the frame and positioned approximately inline with the initial residue flow pattern. The tooth is configured to alter the flow pattern of the residue. The ground engaging tool can be a shank that creates two residue flow patterns.

The tillage apparatus further includes a tube, attached to the frame, to which the ground engaging tool is attached. Additionally, a set of bars is linked to a carrying tube that is connected to the frame. The bars are positioned parallel to each other and to the rear of the ground engaging tools. From these bars, the spike teeth are attached in predetermined positions such as off-center and on-center from the ground engaging tool. Each row of teeth is positioned in a similar manner which can be in relation to the ground engaging tool or the flow pattern of the residue.

In another aspect of the invention, a method is provided for tilling a field. The steps to this method include plowing the field, creating an initial residue flow pattern, altering the initial residue flow pattern to create a second residue flow pattern, and altering the secondary residue flow pattern to create a third residue flow pattern. Further steps to the method include alerting or changing the third residue flow pattern, to create a fourth residue pattern, and altering the fourth residue pattern. Further alteration of the residue pattern is available by adding additional rows of teeth.

In another aspect of the invention, a tillage apparatus includes means for plowing a field, means for creating an initial residue flow pattern, means for altering the initial residue flow pattern to create a second residue flow pattern, and means for altering the secondary residue flow pattern to create a third residue flow pattern. Additional elements for this apparatus are means for altering the third residue flow pattern to create a fourth residue pattern and means for altering the fourth residue pattern.

In another aspect of the present invention, a tillage apparatus includes a frame, a ground engaging tool attached to the frame that creates an initial residue flow pattern and a furrow, a first row of teeth linked to the frame and positioned right of center from the last two rows of the ground engaging tool, and a second row of teeth linked to the frame and positioned left of center from the last two rows of the ground engaging tool. The second row of teeth deposits a portion of the residue into the furrow and the other portion outside the furrow. The tillage apparatus can further include a third row of teeth linked to the frame and positioned approximately inline with the furrow, and a fourth row of teeth linked to the frame and positioned inline with the residue deposited outside of the furrow.

The above and other features and advantages are achieved through the use of a novel tooth positioned in relation to the ground engaging device to efficiently operate in heavy residue fields as herein disclosed.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of the preferred embodiment of the present invention.

FIG. 2 illustrates the residue flow pattern generated by preferred embodiment of the present invention.

FIG. 3 is a flowchart illustrating an embodiment of the present embodiment.

### DETAILED DESCRIPTION OF PREFERRED EMBODIMENTS OF THE INVENTION

A preferred embodiment of the present invention provides a method and apparatus that efficiently tills a field and handles residue that could impair or hamper the tilling process.

The invention incorporates a spike tooth attachment. The purpose of a spike tooth attachment is to trail behind the ground engaging tool and to level out the furrows created by the tool's shanks and to break up larger dirt clods, crop root balls and residue. The spike tooth attachment also helps firm up the ground in preparation for planting the next crop. Additionally, the spike tooth attachment aids in incorporating crop enhancement chemicals into the soil.

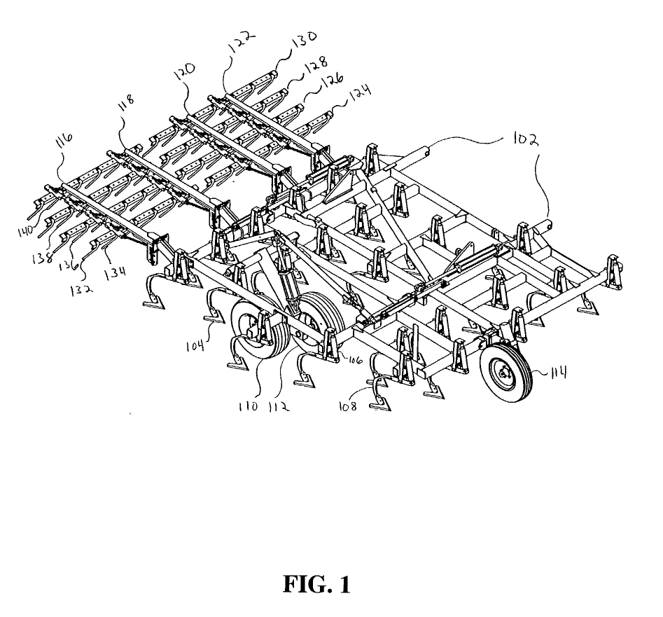

FIG. 1 is a perspective view a tillage apparatus 100 with a spike tooth attached at the rear. The apparatus 100 is approximately one-third of a large tillage device that is primarily used to till fields of substantial sizes. The apparatus 100 is comprised of a number of different components such as a frame 102. The frame 102 provides the basic structure to which various devices are attached to allow tilling of a field. In the preferred embodiment, the frame 102 is a heavy gauge steel which aids in resisting varying forces that occur when operating the machine. The forces occur for example when the tilling apparatus 100 is dragged over uneven or rock laden fields. Furthermore, the size of the tillage apparatus 100, itself, demands a high strength frame structure which enables a tractor to operate it with ease and efficiency.

One of skill in the art recognizes that the frame 102 can be comprised of a number of different compositions such as iron, alloys and so forth. Steel is used in the preferred embodiment due to its durability and low cost structure.

Attached to the frame 102 are a number of ground engaging devices 104. In the preferred embodiment, each ground engaging device 104 is a triangular shaped sweep. The height or depth of the shank 104 is adjustable based upon the set of wheels 110, 112, 114. The wheels enable the operator of the tillage device 100 to sink the ground engaging tool 104 into the field at a desired level. The depth of the ground engaging tool 104 in the field is guided by a number of different factors such as the crop being planted and its needs to survive in the field.

The ground engaging tool 104 is attached to a C-shaped suspension 108, which is attached to the spring 106. The suspension 108 enables the ground engaging tool to resist forces created when tilling is begun. The plurality of ground engaging tools 104 are not linked by the same suspension system. In other words, each ground engaging tool 104 has an independent suspension system 108. One example of the suspension 108 entails using the tillage apparatus 104 in a field that is unusually rocky. At the point in time when a ground engaging tool 104 is pulled through a rocky portion, the effects of the rocks on the ground engaging tool 104 are kept substantially isolated to that ground engaging tool 104 by the suspension 108 and spring 106. This aids in limiting the effects to other ground engaging tools 104 on the frame 102 and in turn the whole tilling process.

The frame 102 is supported by a set of wheels 110, 112, 114, which also allow the operator to control the depth of the ground engaging tool 104. The frame 102, in the preferred embodiment, is hooked to a tractor and pulled over the location where tilling is desired. The wheels 110, 112, 114 are able to be adjusted lower or higher depending on the needs of the operator and/or the conditions of the field. Extending from the rear portion of the frame 100 are carrying arms 116, 118, 120, 122 to which are attached four rows of angle iron bars 124, 126, 128, 130. Attached to the four rows of bars 124, 126, 128, 130 are teeth 132, 134, 136, 138, 140. The teeth are also known as drag spikes.

The teeth 132, 134, 136, 138, 140 serve a number of purposes in the tilling process. A tooth 132 on the bar 124 follows behind the operation of the ground engaging tool 104. The tooth 132 is used to level out the furrows created by the ground engaging tool 104, such as a shank, to break up dirt clods, crop root balls and residue.

Spike tooth systems come in a number of differing shapes and sizes. Some of these systems are five row spike teeth and three row spike teeth. The structural attachment of teeth to the frame and to angle iron bars, via the angle iron bars are attached to the frame in the preferred embodiment, is done with components similar to those used in a five-row tooth section. However, the preferred embodiment uses a four-row tooth system with different positioning of teeth.

In a five-row teeth configuration, five angle iron bars with a series of square holes are punched in at nine-inch intervals. Eleven-inch long, headed, sharpened, square spikes are placed in these holes and held in place by a tri-bend bolt. These bolts go through pairs of holes punched in the perpendicular side of the angle iron that are aligned with the square holes on top. These bars are then attached parallel to each other by means of a bracket that is bolted to the angle iron bar through another series of holes along the top of the angle iron that are spaced approximately every two inches. The brackets are attached to each other by a pivot link that allows for movement between the bars over uneven terrain. The teeth of each bar are not in alignment with each other, but are offset from each other by approximately two inches. This creates an instance whereby there is a tooth approximately every two inches along the width of each section of spike bars. After the spike bars are attached to each other, they are hung by a series of high strength chains from a pair of carrying arms that are bolted at the rear bar section of a ground engaging tool 104. Additionally, there is a pull chain at each carrying arm that attaches at an angle to the front of the spike tooth section. The purpose of this chain is to keep this section of the tillage apparatus from going back during the forward motion of the tool and then riding out of the ground.

In a three-row tooth system, the tooth system is basically a five-row spike tooth with two less bars. However, the less additional tooth rows require repositioning of the teeth. The teeth are spaced three and one-half inches, three and one-half inches and one and two-thirds inches. The uneven pattern between the three and one-half inches and one and two-third inches cause an uneven mixing of chemicals and an uneven pattern following the tooth sections. Additionally, the one and two-third inch section causes residue to collect within the tillage apparatus.

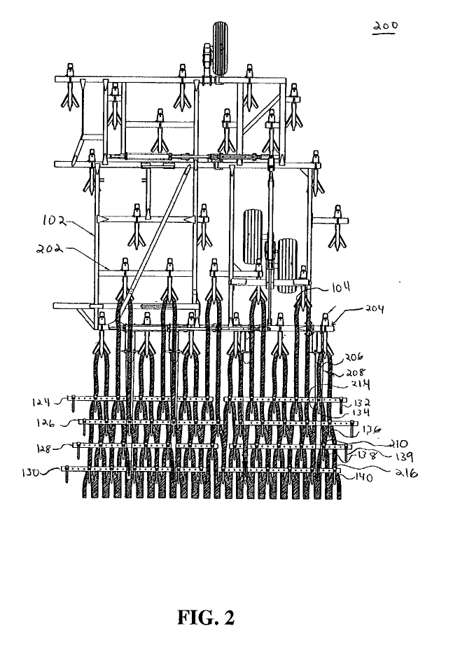

As can be seen in the five and three row tooth systems, it has been common practice in the art to ignore the relationship between the tooth 132 and the ground engaging tool 104. The preferred embodiment of FIG. 2 improves on this approach.

FIG. 2 provides a top view of the preferred embodiment which illustrates the flow pattern of the residue created by the ground-engaging device 104. In the preferred embodiment, in which each of the ground engaging tools is a shank, the tooth 134 is positioned to the left of the ground engaging tool 104 on the rear tube 204. The positioning of the ground engaging tool 104 allows the tooth 134 to alter or disrupt the left side residue flow pattern 206 created by the ground engaging tool 104. The rest of the teeth within the same row of angle iron 124 are positioned in a similar fashion with different shanks 104.

On bar 126, the tooth 136 is placed to the right of the ground engaging tools 104 on the rear 204 tube. This positioning alters residue flow pattern 208 created by the ground engaging tool 104 and spike tooth 134. All the spike teeth on the bar 126 are positioned to alter the right sided flow pattern of the shanks on the front tube 202 and rear tube 204.

On bar 128, the tooth 138 is placed approximately on center or in alignment with the ground engaging tool 104. This positioning alters the residue flow pattern 210 or in other words the residue deposited in the furrow by teeth 134,136. All the teeth on bar 128 are positioned on center with the ground engaging tools on the front 202 and rear 204 tube.

On bar 130, the tooth 140 is placed approximately between the teeth 138, 139. This positioning alters the residue flow pattern 216. The remaining teeth within the same row of angle iron 130 are positioned in a similar fashion with different shanks 104.

In the preferred embodiment, the shank spacing of the rear tube 204 is twenty-four inches with the ground engaging tools on the front tube 202 centered between the ground engaging tools on the rear tube 204. The spacing of the teeth is twelve inches. The rear tube 204 shank spacing may vary. With the movement of the rear tube 204 shanks, consequently the teeth must also changed to be half the distance of the space between the shanks on the rear tube 204. Furthermore, the number of bars from which the teeth are attached, are increased to create and a three-inch interval between the teeth. Additionally, the preferred embodiment ensures that the front tube 202 ground engaging tools split the ground engaging tools on the rear tube 204 shanks.

In operation of the device, as crop residue moves through the tillage apparatus 100, it reaches the ground engaging tools 104 on the front tube 202 and rear tube 204. The ground engaging tools 104 create a furrow by depositing residue to the left and right of the ground engaging tools. The teeth on bar 124 then alter or disrupt the residue flow from the left side of the ground engaging tools 104. A portion of this left sided residue is deposited into the furrow created by the ground engaging tools and the other portion is deposited to the left of the shank furrow. For example, tooth 134 alters residue 206 to deposit approximately half into the shank furrow and the remaining portion to the left 214 of the tooth 132 or furrow.

The teeth on angle iron 126 split the right half of the residue that is split by the ground engaging tools on the front tube 202 and rear tube 204. It deposits approximately half into a furrow created by the ground engaging tools and the remaining portion to the left 210 created by the tooth 132. An example of this is tooth 136 splitting residue pattern 208, half of which merges with furrow created by the shank and the other half of which is deposited to create left flow pattern 210.

The teeth on angle bar 128 follow the furrow created by the shanks on the front tube 202 and rear tube 204. As a result, the residue in the shank furrow is deposited to left and right of the teeth 138.

The teeth on angle bar 130 evenly split the residue created by the tooth 136 of angle bar 126. This creates an even pattern and a level condition behind the tooth section.

In a preferred embodiment, the tooth is a three-quarter inch in diameter and heated treated spring steel is used. Additionally, the length is increased from the typical eleven inches to sixteen inches. The front surface of the tooth is smoothed out for less restriction and smoother crop residue flow. The teeth are spaced at twelve-inch intervals

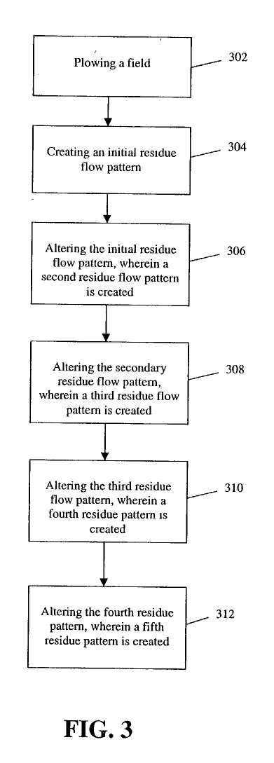

FIG. 3 is a block diagram illustrating an embodiment of the present embodiment. In this embodiment, the step 302 of plowing a field is accomplished with a tillage apparatus. Initial residue is created at step 304 or results from the plowing step 302. The residue, created by the initial plowing 302, is altered to create a second residue pattern 306. The second residue pattern 306 is altered to create a third residue pattern 308. Finally, the third residue pattern is altered to create a fourth residue pattern 310.

In this embodiment as depicted in FIG. 3, the step of plowing 302 creates an initial residue and a furrow in the plowed field. Subsequent to step of plowing 302, the initial residue is altered or disrupted with a step of creating a second residue pattern 306. The step of creating the second residue pattern 306 in this embodiment deposits a portion of its residue into the furrow and the other portion outside the furrow. A step of creating a third residue pattern 308 can be created by altering a portion of the initial residue pattern created by the step of plowing 302 and placing a portion into the furrow and a portion outside the furrow. A step of creating a fourth residue pattern 310 can then be created by altering the residue placed in the furrow by the steps of creating of second residue 306 and creating a third residue 308. A step of creating a fifth residue pattern 312 can also be created by altering the second pattern residue placed outside the furrow.

The many features and advantages of the invention are apparent from the detailed specification, and thus, it is intended by the appended claims to cover all such features and advantages of the invention which fall within the true spirits and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A tillage apparatus, comprising:
a frame;
a ground engaging tool attached to the frame that creates an initial residue flow pattern; and
a plurality of teeth linked to the fame and positioned approximately inline with the initial residue flow pattern, configured to alter the flow pattern of the residue.

2. The tillage apparatus as claim 1, wherein the ground engaging tool is a shank.

3. The tillage apparatus as in claim 1, wherein the frame comprises a tube to which the ground engaging tool is attached.

4. The tillage apparatus as in claim 3, wherein the frame further comprises a carrying arm attached to the tube.

5. The tillage apparatus as in claim 4, further comprising a first bar linked to the carrying tube.

6. The tillage apparatus as claim 5, wherein a plurality of first teeth are linked to the first bar.

7. The tillage apparatus as claim 5, wherein the plurality of first teeth are positioned off center from the ground engaging tool.

8. The tillage apparatus as claim 7, wherein the first teeth are positioned approximately three inches off center from the center of the ground engaging tool.

9. The tillage apparatus as claim 5, wherein a second bar is linked to the carrying arm.

10. The tillage apparatus as in claim 4, wherein a plurality of second teeth are attached to the second bar and positioned off center from the ground engaging tool.

11. The tillage apparatus as in claim 9, further comprising a third bar linked to the carrying arm.

12. The tillage apparatus as in claim 11, wherein a plurality of third teeth are attached to the third bar and positioned approximately on center with the ground engaging tool.

13. The tillage apparatus as claim 11, further comprising a fourth bar linked to the carrying arm.

14. The tillage apparatus as in claim 13, wherein a plurality of fourth teeth are attached to the fourth bar and positioned approximately centered between the plurality of teeth on the third bar.

15. A method for tilling a field, comprising the steps of:
plowing the field;
creating an initial residue flow pattern;
altering the initial residue flow pattern to create a second residue flow pattern; and
altering the secondary residue flow pattern to create a third residue flow pattern.

16. The method as in claim 15, further comprising the step of altering the third residue flow pattern to create a fourth residue pattern is created.

17. The method as in 16, further comprising the step of altering the fourth residue pattern.

18. An tillage apparatus comprising
means for plowing a field;
means for creating an initial residue flow pattern;
means for altering the initial residue flow pattern to create a second residue flow pattern; and
means for altering the secondary residue flow pattern to create a third residue flow pattern.

19. The tillage apparatus as in claim 18, further comprising means for altering the third residue flow pattern, wherein a fourth residue pattern is created.

20. The tillage apparatus as in 19, further comprising means for altering the fourth residue pattern.

21. A tillage apparatus comprising:
a frame;
a ground engaging tool attached to the frame that creates an initial residue flow pattern and a furrow;
a first row of teeth linked to the fame and positioned right of center from the ground engaging tool; and
a second row of teeth linked to the frame and positioned left of center from the ground engaging tool.

22. The tillage apparatus as in claim 21, wherein the second row of teeth deposits a portion of the residue into the furrow and the other portion outside the furrow.

23. The tillage apparatus as in claim 21 further comprising a third row of teeth linked to the frame and positioned approximately inline with the furrow.

24. The tillage apparatus as in claim 22 further comprising a fourth row of teeth linked to the frame and positioned inline with the residue deposited outside of the furrow.
